(19) United States
(12) Patent Application Publication
(10) Pub. No.: US 2016/0187064 A1
(43) Pub. Date: Jun. 30, 2016

(54) CRUCIBLE

(71) Applicant: JI ZHUN PRECISION INDUSTRY (HUI ZHOU) CO. LTD., Huizhou (CN)

(72) Inventors: DAO ZHANG, Shenzhen (CN); KAI LUO, Shenzhen (CN); XIAO-BO YUAN, Shenzhen (CN); YI-MIN JIANG, Shenzhen (CN); JUN-QI LI, Shenzhen (CN)

(21) Appl. No.: 14/718,885

(22) Filed: May 21, 2015

(30) Foreign Application Priority Data
Dec. 30, 2014 (CN) 201410838849.6

(51) Int. Cl. F27B 14/10

(52) U.S. Cl. CPC F27B 14/10

(57) ABSTRACT

A crucible for melting metals includes a main body, a bottom portion, and a strengthening annular portion. The bottom portion is sealed to a first end of the main body. The strengthening annular portion is disposed on a second end of the main body. The main body, which is also thicker towards the bottom portion for additional strength, and the bottom portion are composed primarily of graphite, and the strengthening annular portion is composed of a ceramic material or fireproof material or both.

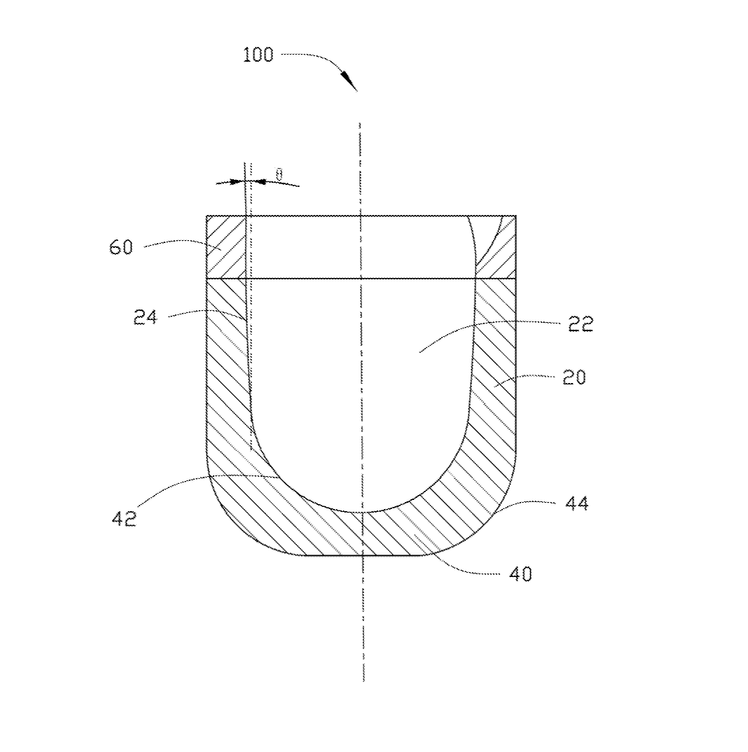

### FIELD

The subject matter herein generally relates to a crucible for melting metals, and more particularly for melting bulk amorphous metal alloys.

### BACKGROUND

A crucible may be made of graphite for melting bulk amorphous metal alloys due to heat conductivity.

### BRIEF DESCRIPTION OF THE DRAWINGS

Implementations of the present technology will now be described, by way of example only, with reference to the attached FIGURE.

The FIGURE is a cross-sectional view of a crucible for melting metals.

### DETAILED DESCRIPTION

It will be appreciated that for simplicity and clarity of illustration, where appropriate, reference numerals have been repeated among the different FIGURES to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is in relation to a crucible that can include a main body, a bottom portion and a strengthening annular portion. The bottom portion can be sealed to a first end of the main body. The strengthening annular portion can be disposed on a second end of the main body. The main body and the bottom portion can be composed primarily of graphite, and the strengthening annular portion can be composed of a ceramic material or a fireproof material or both.

The FIGURE illustrates a crucible 100 configured for accommodating a metal sample (not shown), such as, but not limited to, a bulk amorphous metal alloy. The crucible 100 can include a main body 20, a bottom portion 40, and a strengthening annular portion 60. The main body 20 can be substantially a cylindrical structure. The bottom portion 40 can be sealed to a first end of the main body 20. The main body 20 and the bottom portion 40 can be mainly made of graphite due to graphite having a good conductivity of heat. The strengthening annular portion 60 can be disposed on a second end of the main body 20 away from the bottom portion 40. The strengthening annular portion 60 can be made of a ceramic material or a fireproof material or both. In the preferred embodiment, the strengthening annular portion 60 can be made of corundum.

In order to improve mechanical strength and thermal stability, the main body 20 or the bottom portion 40 can be made of a composite material, which can include graphite, reinforcing fibers, and fireproof material. In the preferred embodiment, the reinforcing fibers contained in the main body 20 or the bottom portion 40 can be from about 1% (wt) to about 10% (wt). The fireproof material contained in the main body 20 or the bottom portion 40 can be from about 1% (wt) to about 10% (wt). The reinforcing fibers can be chosen from a group including carbon fibers, quartz fibers, and the like. The fireproof material can be one chosen from a group including aluminum oxide, magnesium oxide, calcium oxide, chromium hemitrioxide, silicon dioxide, and the like.

The main body 20 and the bottom portion 40 can cooperatively define a cavity 22 for accommodating the metal sample. In an alternative embodiment, an inner surface 24 of the main body 20 can slant relative to a central axis of the crucible 100, allowing a sidewall of the main body 20 to be gradually thicker towards the bottom portion 40. This construction enhances a mechanical strength of a connecting portion between the main body 20 and the bottom portion 40, so that the crucible 100 can withstand the impact and weight of a falling metal sample. In the preferred embodiment, an included angle θ defined between the inner surface 24 and the central axis can be less than 25 degrees.

In the illustrated embodiment, the inner surface 42 of the bottom portion 40 can be substantially arc-shaped and connected with an inner surface of the main body 20. An outer surface 44 of the bottom portion 40 can also be substantially arc-shaped and connected with an outer surface of the main body 20, allowing the crucible 100 to be put in an apparatus, such as an induction furnace.

The embodiments shown and described above are only examples. Many details are often found in the art such as other features of a crucible. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A crucible comprising:
a main body;
a bottom portion sealed to a first end of the main body; and
a strengthening annular portion disposed on a second end of the main body;
wherein the main body and the bottom portion are composed primarily of graphite, and the strengthening annular portion is composed of a ceramic material or a fireproof material or both.

2. The crucible of claim 1, wherein the main body or the bottom portion is made of a composite material comprising graphite, reinforcing fibers, and fireproof material.

3. The crucible of claim 2, wherein the reinforcing fibers are carbon fibers.

4. The crucible of claim 2, wherein the fireproof material is one chosen from a group comprising aluminum oxide, magnesium oxide, calcium oxide, chromium hemitrioxide, and silicon dioxide.

5. The crucible of claim 2, wherein a content of the reinforcing fibers is in a range from about 1% (wt) to about 10% (wt).

6. The crucible of claim 2, wherein a content of fireproof material is in a range from about 1% (wt) to about 10% (wt).

7. The crucible of claim 1, wherein the strengthening annular portion is made of corundum.

8. The crucible of claim 1, wherein an inner surface of the main body slant relative to a central axis of the crucible.

9. The crucible of claim 8, wherein an included angle defined between the inner surface and the central axis is less than 25 degrees.

10. The crucible of claim 1, wherein a sidewall of the main body is gradually thicker towards the bottom portion.

11. The crucible of claim 1, wherein an inner surface of the bottom portion is arc-shaped and connected with an inner surface of the main body.

12. The crucible of claim 1, wherein an outer surface of the bottom portion is arc-shaped and connected with an outer surface of the main body.
